(19) United States
(12) Patent Application Publication
(10) Pub. No.: US 2016/0091978 A1
(43) Pub. Date: Mar. 31, 2016

(54) GESTURE RECOGNITION APPARATUS, VEHICLE HAVING THE SAME AND METHOD FOR CONTROLLING THE SAME

(71) Applicant: HYUNDAI MOTOR COMPANY, Seoul (KR)

(72) Inventor: Hyungsoon PARK, Seoul (KR)

(21) Appl. No.: 14/563,526

(22) Filed: Dec. 8, 2014

(30) Foreign Application Priority Data
Sep. 25, 2014 (KR) 10-2014-0128185

(51) Int. Cl. G06F 3/01

(52) U.S. Cl. CPC G06F 3/017

(57) ABSTRACT

A vehicle includes a collector for collecting information about a subject, comprising a first detector for detecting movement of the collector; and a gesture recognition apparatus for recognizing a gesture based on the information on the subject. The gesture recognition apparatus includes a storage unit for storing an operating instruction for an electronic device which corresponds to the gesture information; and a controller for correcting the recognized gesture information based on information on the movement of the collector, and determining an operating instruction for an electronic device which corresponds to the corrected gesture information.

### CROSS-REFERENCE TO RELATED APPLICATION(S)

This application claims the benefit under 35 U.S.C. §119(a) of a Korean patent application filed on Sep. 25, 2014 in the Korean Intellectual Property Office and assigned Serial No. 10-2014-0128185, the entire disclosure of which is incorporated hereby incorporated by reference.

### TECHNICAL FIELD

The present subject matter relates to a gesture recognition apparatus, a vehicle having the apparatus, and a method for controlling the apparatus, by which a gesture intended by a user can be recognized.

### BACKGROUND

Vehicles basically run on the road but also provide various user convenience functions, such as audio play, video play, navigation, air conditioning (AC) and ventilation, seat control, lighting control, etc.

To provide these functions, various electronic devices for performing the functions and input units for receiving operating instructions for the electronic devices are equipped in the vehicle.

The input units for the electronic devices may be integrated on a single panel, or may be separately arranged on different panels.

The input units may be implemented in at least one of hard key, touch, voice recognition, and gesture recognition schemes.

When the input units are implemented using the hard key scheme, many hard keys may physically take up wide spaces or cause a problem for the user to manipulate few hard keys if only very few hard keys are used to receive operating instructions for the electronic devices. Furthermore, light emitting diode (LED) button lights and corresponding mechanisms are required for identifying the hard keys in the dark, thereby increasing manufacturing costs.

When the input units are implemented with a touch screen, the driver needs to apply touches one by one on the touch screen to provide operating instructions, which may negatively affect safe driving.

Finally, when the input units are implemented in the gesture recognition scheme, if an unnatural gesture or unintended hand gesture is made, the operating instruction may not be recognized, or if a device to detect the hand gesture is moved due to an external force, the gesture may also be misrecognized.

### SUMMARY

The present disclosure provides a gesture recognition apparatus, vehicle having an apparatus, and method for controlling the apparatus, by which recognized gesture information may be corrected based on movement of a collector for collecting information about a subject.

The present disclosure also provides a gesture recognition apparatus, vehicle having an apparatus, and method for controlling the apparatus, by which recognized gesture information may be corrected based on movement of a collector for collecting information about a subject and movement of the vehicle.

The present disclosure also provides a gesture recognition apparatus, vehicle having an apparatus, and method for controlling the apparatus, by which recognized gesture information may be corrected based on movement of the vehicle.

In accordance with an aspect of the present disclosure, a vehicle includes a collector for collecting information on a subject; a first detector for detecting movement of the collector; a second detector for detecting movement of the vehicle; and a gesture recognition apparatus for recognizing a gesture based on information on the subject, wherein the gesture recognition apparatus includes: a storage unit for storing an operating instruction for an electronic device which corresponds to the gesture information; and a controller for correcting the recognized gesture information based on information on movement of the vehicle and information on movement of the collector, and determining an operating instruction for an electronic device which corresponds to the corrected gesture information.

The controller may obtain information about a form of the gesture in correcting the gesture information.

The gesture recognition apparatus may further include a communication unit for receiving traveling information of the vehicle, and the controller may obtain information on movement of the vehicle based on the traveling information, make an additional correction to the corrected gesture information based on the information on the movement of the vehicle, and determine an operating instruction for an electronic device which corresponds to the additionally corrected gesture information.

The traveling information of the vehicle may include information on wheel speed of the vehicle and information on actual speed of the vehicle.

The vehicle may further include a second detector for detecting the movement of the vehicle, wherein the gesture recognition apparatus may further include a communication unit for receiving the information on the movement of the vehicle, and the controller may make an additional correction to the corrected gesture information based on the information on the movement of the vehicle, and determine an operating instruction for an electronic device which corresponds to the additionally corrected gesture information.

The second detector may include at least one of an acceleration sensor, a yaw rate sensor, a gyro sensor, and a wheel speed sensor.

In accordance with another aspect of the present disclosure, a gesture recognition apparatus includes a collector for collecting information on a subject; a detector for detecting movement of the collector; a storage unit for storing an operating instruction for an electronic device which corresponds to the gesture information; and a controller for obtaining gesture information based on the information on the subject, correcting the gesture information based on the information on movement of the collector, and determining an operating instruction for an electronic device which corresponds to the corrected gesture information; and an output unit for outputting the operating instruction to the electronic device.

The collector may include an image collector for collecting an image of the subject for gesture recognition.

The collector may include an optical sensor for receiving light reflected from the subject.

The controller may obtain information on a form of the gesture in correcting the gesture information.

The gesture recognition apparatus may further include a communication unit for receiving traveling information of a vehicle, wherein the controller may obtain information on movement of the vehicle based on the traveling information, and make an additional correction to the corrected gesture information based on the information on movement of the vehicle.

The gesture recognition apparatus may further include a communication unit for receiving information on movement of a vehicle, wherein the controller may make an additional correction to the corrected gesture information based on the information on the movement of the vehicle.

The collector and the detector are integrated into a unit.

The information of movement of a vehicle may include at least one of acceleration information, yaw rate information, angular speed information, wheel speed information, and actual speed information of the vehicle.

In accordance with another aspect of the present disclosure, a method for controlling a gesture recognition apparatus included in a vehicle includes collecting information on a subject within the vehicle by means of a collector; obtaining a gesture of the subject; detecting movement of the collector in collecting the information on the subject; correcting information on the gesture based on the information on the movement of the collector; determining an operating instruction for an electronic device which corresponds to the corrected gesture information; and outputting the operating instruction to the electronic device.

Correcting information on the gesture based on the information on the movement of the collector may include receiving traveling information of the vehicle; obtaining information on movement of the vehicle based on the traveling information; and making an additional correction to the corrected gesture information based on the information on the movement of the vehicle.

Correcting information on the gesture based on the information on the movement of the collector may include receiving information on movement of the vehicle; and making an additional correction to the corrected gesture information based on the information on the movement of the vehicle.

The information of movement of a vehicle may include at least one of acceleration information, yaw rate information, angular speed information, wheel speed information, and actual speed information of the vehicle.

Other aspects, advantages, and salient features of the disclosure will become apparent to those skilled in the art from the following detailed description, which, taken in conjunction with the annexed drawings, discloses exemplary embodiments of the disclosure

### BRIEF DESCRIPTION OF THE DRAWINGS

The above and other features and advantages of the present disclosure will become more apparent by describing in detail exemplary embodiments thereof with reference to the attached drawings in which:

FIG. 1 shows a vehicle equipped with a gesture recognition apparatus, according to an embodiment;

FIG. 2 shows the interior of a vehicle equipped with a gesture recognition apparatus, according to an embodiment;

FIG. 3 is a block diagram of a gesture recognition apparatus, according to an embodiment;

FIG. 4 is a flowchart illustrating a method for controlling a gesture recognition apparatus, according to an embodiment;

FIG. 5 shows how to recognize a gesture in a gesture recognition apparatus, according to an embodiment;

FIG. 6 is a block diagram of a gesture recognition apparatus, according to another embodiment;

FIG. 7 is a flowchart illustrating a method for controlling a gesture recognition apparatus, according to another embodiment;

FIGS. 8 and 9 show how to recognize a gesture in a gesture recognition apparatus, according to another embodiment;

FIG. 10 is a block diagram of a gesture recognition apparatus, according to another embodiment;

FIG. 11 is a flowchart illustrating a method for controlling a gesture recognition apparatus, according to another embodiment;

FIG. 12 shows how to recognize a gesture in a gesture recognition apparatus, according to another embodiment; and

FIG. 13 shows how to recognize a gesture in a gesture recognition apparatus, according to another embodiment.

Throughout the drawings, like reference numerals will be understood to refer to like parts, components, and structures.

### DETAILED DESCRIPTION

The present disclosure will now be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Like reference numerals in the drawings denote like elements, and thus their description will be omitted. In the description of the present disclosure, if it is determined that a detailed description of commonly-used technologies or structures related to the embodiments of the present disclosure may unnecessarily obscure the subject matter of the invention, the detailed description will be omitted. It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

Embodiments of the present invention will now be described with reference to accompanying drawings.

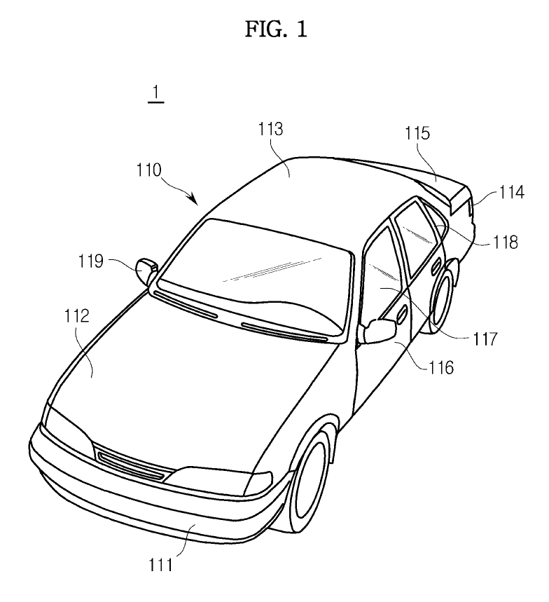

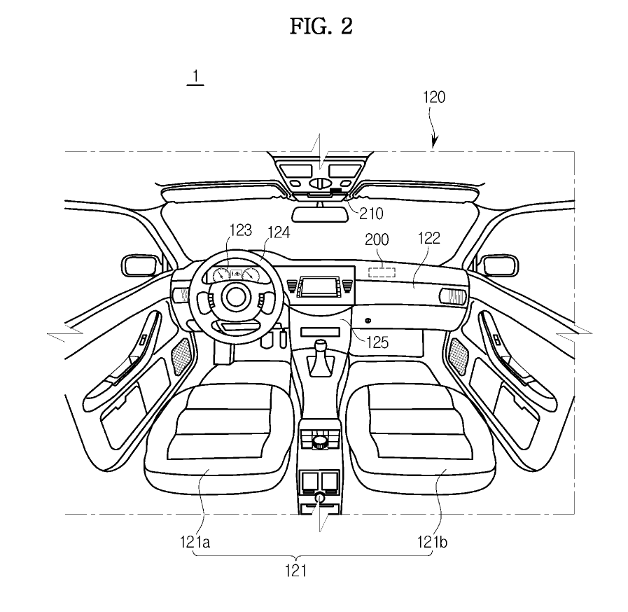

FIG. 1 shows a vehicle equipped with a man-machine interface, according to an embodiment of the present disclosure, and FIG. 2 shows the interior of a vehicle equipped with the man-machine interface, according to an embodiment of the present disclosure.

A vehicle 1, a device that drives wheels for the purpose of transportation of humans or goods moves on the road.

The vehicle 1 includes a body with exterior and interior parts, and remaining parts, i.e., chassis on which mechanical devices required for driving are installed.

Referring to FIG. 1, the exterior part 110 includes a front bumper 111, a hood 112, a roof panel 113, a rear bumper 114, a trunk 115, front, back, left and right doors 116, and window glasses 117 equipped in the front, back, left and right doors 116.

The exterior part 110 further includes fillers 118 located between the front bumper 111, the hood 112, the roof panel 113, the rear bumper 114, the trunk 115, the front, back, left and right window glasses.

Further, the exterior part 110 includes the window glasses (or side window glasses) equipped in the front, back, left and right doors 116, quarter window glasses located between the fillers 118 which may not be opened, a rear window glass installed on the back, a front window glass installed on the front.

The exterior part 110 further includes side mirrors 119 that helps the driver see areas behind the vehicle 1.

The chassis of the vehicle 1 includes a power generating system, a power transfer system, a traveling gear, a steering system, a braking system, a suspension system, a transmission system, a fuel system, front, rear, left, and right wheels, etc.

The vehicle 1 further includes various safety systems for safety of the driver and passengers.

The safety systems may include an airbag control unit for the purpose of the safety of driver and passengers in case of a car accident and an Electronic Stability Control (ESC) unit for stabilizing the vehicle's position in acceleration or cornering of the vehicle 1.

Moreover, the vehicle 1 may optionally include various detectors, such as proximity sensors for detecting obstacles or other cars behind or to the side of the vehicle 1, a rain sensor for detecting rainfall and precipitation, temperature sensors for detecting internal/external temperature, a wheel speed sensor for detecting the speed of the front, rear, left and right wheels, an acceleration sensor for detecting acceleration, a yaw rate sensor for detecting yaw rates, a gyro sensor for detecting the position of the vehicle.

The vehicle 1 includes an Electronic Control Unit (ECU) for controlling operation of the power generating system, power transfer system, traveling gear, steering system, braking system, suspension system, transmission system, fuel system, various safety systems and sensors.

Furthermore, the vehicle 1 may optionally include electronic devices, such as an AC and ventilation system, a lighting system, a navigation system, seat heaters, a hands-free system, a GPS system, audio equipment and Bluetooth device, a rear camera, a charging system for an external terminal, E-Z pass (hi-pass in Korea) equipment, etc.

In addition, the vehicle 1 may optionally include some other electronic devices, such as a sunroof open/close system for automatically opening or closing the sunroof, a door open/close system for automatically opening or closing the doors, a window open/close system for automatically opening or closing the windows, etc.

The vehicle 1 may further include an engine start button to provide an operation instruction to a start motor (not shown).

Specifically, a pushing of the engine start button drives the start motor, which in turn drives the power generating system, i.e., an engine (not shown).

The vehicle 1 further includes a battery (not shown) electrically connected to the navigation system, audio equipment, indoor lighting system, start motor, and other electronic devices for supplying power.

The battery is charged by means of power of the internal generator or the engine while the vehicle is driving.

Referring to FIG. 2, the interior part 120 of the body includes seats 121 (121a and 121b), a dashboard 122, an instrument cluster (or cluster) 123 placed on the dashboard, containing gauges and indicators, such as a tachometer, speedmeter, water temperature gauge, fuel gauge, turn signal indicator, head light indicator, warning light, seat belt warning light, odometer, gearshift position indicator, door open warning light, low fuel warning light, low oil pressure warning light, etc., a steering wheel 124 for steering control of the vehicle, and a center fascia 125 having a control pad for audio equipment and AC and ventilation system.

The seats 121 include a driver seat 121a, a passenger seat 121b, and back seats located in the back of the interior of the vehicle 1.

The cluster 123 may be digitally implemented. The digitally implemented cluster displays car information and traveling information in images.

The center fascia 125 is located on the dashboard between the driver seat 121a and the passenger seat 121b and the control panel mounted on the center fascia 125 has multiple buttons arranged to control the audio equipment, AC and ventilation system, and seat heaters.

Vents, a cigar jack, etc., may also be installed on the center fascia 125.

There may also be a terminal device (e.g., the navigation system) mounted on the center fascia 125 for receiving information from the user and outputting corresponding results.

The vehicle 1 may include a gesture recognition apparatus 200 for controlling operation of the various electronic devices as mentioned above based on operating instructions input by the user.

Specifically, the gesture recognition apparatus 200 receives operating instructions for the various electronic devices and forwards the operating instructions to the respective electronic devices.

In an embodiment of the present disclosure, the gesture recognition apparatus 200 recognizes the user's gesture, determines an operating instruction that corresponds to the recognized gesture, and outputs the operating instruction to the corresponding electronic device.

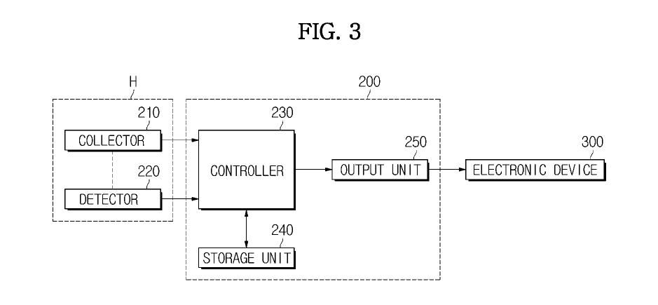

Such a gesture recognition apparatus will be described in more detail in connection with FIG. 3.

FIG. 3 is a block diagram of the gesture recognition apparatus 200, according to an embodiment.

Referring to FIG. 3, the gesture recognition apparatus 200 includes a controller 230, a storage unit 240, and an output unit 250, receiving a signal sent from a collector 210 and detector 220, recognizing a gesture based on the received signal, and determining an operating instruction that corresponds to the recognized gesture.

The gesture recognition apparatus 200, the collector 210, and the detector 220 may also be integrated in a single module.

The collector 210 detects a subject (e.g., the user's hand) and sends the controller 230 a detection signal containing information regarding the form and movement of the subject.

The collector 210 includes an image collector for collecting (or capturing) an image of the subject.

The image collector may be a single camera, two cameras for collecting images of the subject at different locations, or a three dimensional (3D) camera.

The collector 210 may include a capacitive sensor for detecting capacitance of the subject, an ultrasonic sensor for detecting a distance to the subject, or an optical sensor for detecting light reflected from the subject.

The detector 220 may be integrated in the collector 210, or arranged with the collector 210 in a housing H.

The detector 220 detects a movement of the collector 210 and sends the detection result to the controller 230.

Specifically, the detector 220 may correspond to a vibration detector for detecting vibration of the collector 220, including an acceleration sensor or a gyro sensor.

The controller 230 recognizes a gesture based on the subject detection signal collected by the collector 210.

Operation of the controller 230 for recognizing a gesture will be described below in more detail depending on various types of the image collector.

For example, the controller 230 may obtain a two dimensional (2D) image using an image collected by a single camera, determine whether the subject exists in the 2D image, and recognize a gesture intended by the user by checking the form and moving direction of the subject if it is determined that the subject exists in the 2D image.

In another example, the controller 230 may obtain a 3D image using two 2D images collected by two cameras, determine whether the subject exists in the 3D image, and recognize a gesture intended by the user by checking the form and moving direction of the subject, if the subject exists in the 3D image.

In yet another example, the controller 230 may obtain a 3D image using an image collected by a 3D camera, determine whether the subject exists in the 3D image, and recognize a gesture intended by the user by checking the form and moving direction of the subject if the subject exists in the 3D image. The image of the subject collected by the collector 210 may include motion blur due to vibration of the collector 210.

The gesture information recognized by the controller 230 may include gesture form information that contains motion blur.

Accordingly, upon recognition of a gesture, the controller 230 may correct the recognized gesture information based on a movement of the collector 210 and then determine an operating instruction for an electronic device 300 that corresponds to the corrected gesture information.

For example, the controller 230 may set at least a part of the subject in the image as a reference part, and correct the form information of the subject by adjusting the reference part based on the extent and direction of the movement of the collector 210.

Accordingly, the form of the gesture made by the user may be obtained. It is also possible for the controller 230 to correct the gesture information by sequentially applying information about movements over time while the subject is detected.

For example, if a subject has been detected for 2 seconds, the controller 230 may make a first correction to an image of the subject based on the direction and extent of movements of the collector for 1 second from the start of detection and make a second correction to the first corrected image based on the direction and extent of movements of the collector for the remaining 1 second.

Accordingly, the controller 230 may obtain an accurate form of the gesture by eliminating a motion blur component from the information regarding the recognized form of the gesture, i.e., obtain motion blurry gesture information.

Furthermore, the controller 230 recognizes movements of the gesture by determining positions of the corrected gesture in time.

Here, information regarding the gesture movements may include moving directions and moving distances of the subject.

The storage unit 240 may store operating instructions for the respective multiple electronic devices, and store gesture information that corresponds to an operating instruction to control each electronic device.

The multiple electronic devices may include thane AC and ventilation system for controlling temperature in the vehicle, audio equipment for radio tuning and music file reproduction, a navigation system for aiding in navigation, multiple lighting devices for controlling brightness of the interior of the vehicle, an outdoor lighting control device (e.g., headlights), a Bluetooth system for communication with an external terminal device, a heater for providing heat for seats, window open/close systems for automatically opening or closing windows, a sunroof open/close system for automatically opening or closing a sunroof, a door open/close system for automatically opening or closing a doors, and a door lock (not shown) for locking or unlocking the doors.

The storage unit 240 may also store operating instructions for at least two electronic devices corresponding to a single gesture.

The output unit 250 is connected to the multiple electronic devices for outputting the operating instructions for the at least one electronic device.

The output unit 250 may include digital ports and analog ports connected to the multiple electronic devices.

Moreover, the output unit 250 may communicate with the multiple electronic devices through the Controller Area Network (CAN) communication protocol.

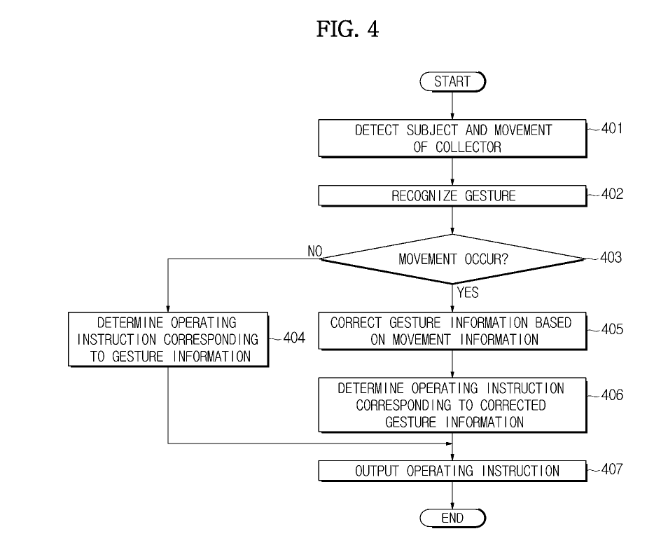

FIG. 4 is a flowchart illustrating a method for controlling a gesture recognition apparatus in the interior of a vehicle, according to an embodiment.

The gesture recognition apparatus collects an image of the interior of the vehicle when the driver or a passenger is in the vehicle and detects a movement of an image collector (or collector), in operation 401.

The reason for performing image collection and movement detection together is to determine whether vibration of the collector occurs at a moment when the image containing the subject is captured (or collected).

This is because motion blur is likely to occur in the collected image when the collector vibrates due to an external force applied to the collector while the collector is collecting the image.

The gesture recognition apparatus processes the collected image, determines whether a subject is contained in the processed image, and recognizes a gesture of the subject if it is determined that the subject exists in the image, in operation 402.

Recognizing a gesture includes recognizing information regarding the form and movement of the subject.

Then the gesture recognition apparatus determines whether the collector is moved due to vibration at the moment when the image of the subject is captured, in operation 403, and determines an operating instruction for an electronic device that corresponds to the recognized gesture if it is determined that no vibration of the collector has occurred, in operation 404.

On the other hand, if it is determined that the collector has been moved at the moment when the image of the subject is captured, the gesture recognition apparatus corrects the recognized gesture information based on information about the movement of the collector, in operation 404, and determines an operating instruction for an electronic device that corresponds to the corrected gesture.

The gesture recognition apparatus then outputs the operating instruction to the electronic device.

If the collector is moved due to vibration applied to the collector at the moment when the image of the subject is captured, motion blur may be contained in the image of the subject. Thus, the gesture recognition apparatus may correct the recognized gesture information based on information on movement of the collector in order to eliminate motion blur from the image and thus obtain an image including an original form of the subject.

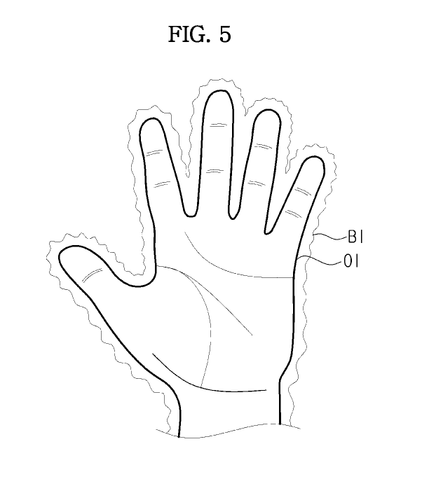

Referring to FIG. 5, the gesture recognition apparatus sets at least a part in the image BI where motion blur occurs as a reference part (e.g., an edge part), and obtain a motion blur-free image (OI) resulting from correction of the form of the subject by adjusting the reference part based on information on the extent and direction of movement of the collector 210.

Furthermore, the gesture recognition apparatus may obtain the information on movements of the subject by checking corrected subject positions over time, and recognize a gesture based on the corrected information on the form and movement of the subject.

A more accurate image of the gesture may be obtained by eliminating noise from the recognized gesture information based on the information on the movement of the collector.

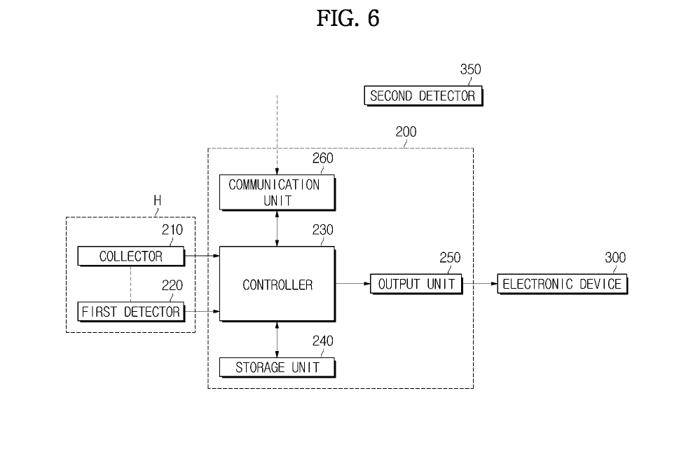

FIG. 6 is a block diagram of the gesture recognition apparatus 200, according to another embodiment.

Referring to FIG. 6, the gesture recognition apparatus 200 includes controller 230, the storage unit 240, the output unit 250, and a communication unit 260, receiving a signal sent from the collector 210, a first detector 220, and a second detector 350, recognizing a gesture based on the received signal, and determining an operating instruction that corresponds to the recognized gesture.

The first detector 220 is the same as the aforementioned detector 220 of the embodiment of FIG. 3, but is termed ‘first detector’ to be distinguished from the second detector 350.

The second detector 350 equipped in the vehicle detects movement of the vehicle and sends information on the movement of the vehicle to the gesture recognition apparatus 200.

The second detector 350 detects traveling movement, posture, etc., of the vehicle, including at least one of wheel speed, acceleration, yaw rate, angular speed of the vehicle.

Accordingly, the second detector 350 may include at least one of the wheel speed sensor, the acceleration sensor, the yaw rate sensor, and the gyro sensor.

The gesture recognition apparatus 200, the collector 210, and the first detector 220 may be integrated in a single module.

In this embodiment, as the collector 210, first detector 220, storage unit 240, and output unit 250 are the same as what are shown in the previous embodiment of FIG. 3, description of them will be omitted.

The controller 230 recognizes the gesture based on the subject detection signal collected by the collector 210.

An image of the subject, which may be the subject detection signal, may contain motion blur due to movement of the vehicle or movement of the collector.

Specifically, the collector 210 mounted on the vehicle may be moved as the vehicle moves, and as the mutual positions between the collector 210 and the subject are instantaneously changed, a gesture having different movement information than is intended by the user may be recognized.

Furthermore, as the vehicle movement or an external force affects the collector, the collector may vibrate and thus a gesture conveying different appearance information than intended by the user may be recognized.

That is, the gesture information recognized by the controller 230 may include motion blur.

Accordingly, upon recognition of the gesture, the controller 230 may make a first correction to the recognized gesture information based on information regarding the movement of the vehicle, make a second correction to the corrected gesture information based on movement information of the collector 210, and then determine an operating instruction for an electronic device 300 that corresponds to the twice corrected gesture information.

For example, the controller 230 may set at least one part of the subject in the image as a reference part, adjust the reference part based on information regarding the extent and direction of the movement of the vehicle, and make an additional correction to the subject form information by further adjusting the adjusted reference part based on the extent and direction of the movement of the collector 210.

Accordingly, information on the form and movement of the gesture made by the user may be obtained.

The information on movement of the vehicle may include information on acceleration of the vehicle.

The controller 230 may receive information on the speed of all the wheels from the wheel speed sensor equipped in the vehicle, obtain information about the actual speed of the vehicle based on the information on the received speed of all the wheels, and obtain information on acceleration of the vehicle based on the information on the actual speed of the vehicle.

The controller 230 may also obtain the information on acceleration of the vehicle based on information on the yaw rate received from the yaw rate sensor equipped in the vehicle.

The controller 230 may also obtain the information on acceleration of the vehicle based on information on angular speed information received from the gyro sensor equipped in the vehicle.

It is also possible for the controller 230 to directly receive the information on the acceleration of the vehicle from the acceleration sensor equipped in the vehicle.

The controller 230 may correct information on gesture movements by sequentially applying information on movements of the vehicle and collector 210 over time while the subject is detected.

For example, if a subject has been detected for 2 seconds, the controller 230 may make a first correction to an image of the subject based on directions and extents of movements of the vehicle and collector for 1 second from the start of detection and make a second correction to the first corrected image based on directions and extents of movements of the vehicle and collector for the remaining 1 second.

Making the first and second corrections to the image of the subject includes correcting the position and form of the subject.

By doing this, the controller 230 may obtain a more accurate form of the gesture by eliminating the motion blur part from the recognized gesture form information, i.e., obtain motion blur free gesture information, and obtain information on the movement of the gesture by checking a change in positions of the corrected gesture over time.

Here, the movement information may include moving directions and moving distances of the subject.

The communication unit 260 may communicate with the second detector 350 and send the controller 230 information about the movement of the vehicle detected by the second detector 350.

The communication unit 260 may perform communication through the CAN communication protocol.

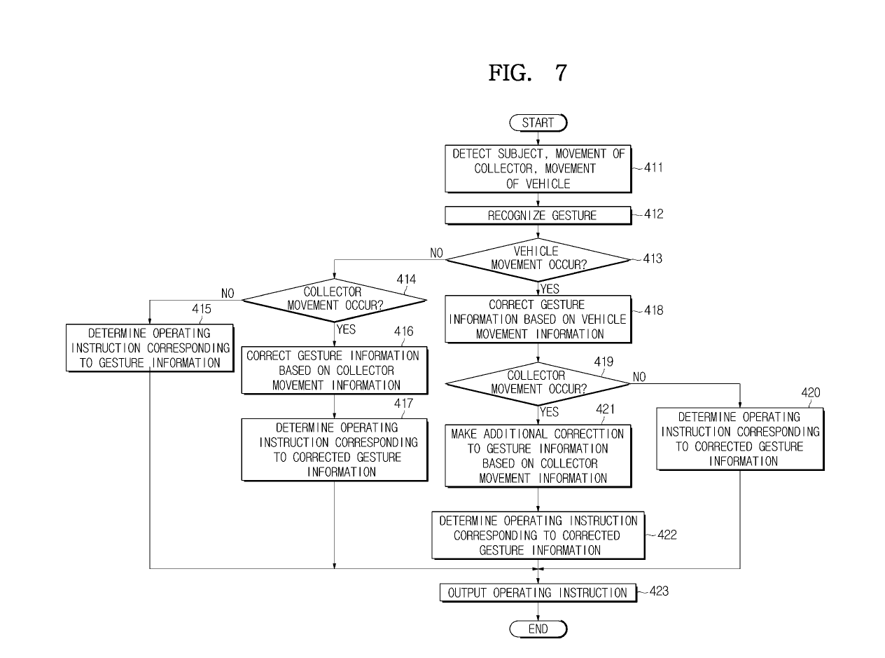

FIG. 7 is a flowchart illustrating a method for controlling a gesture recognition apparatus in the interior of a vehicle, according to another embodiment.

The gesture recognition apparatus collects an image of the interior of the vehicle when the driver or a passenger is in the vehicle, detects a movement of the collector 210, and obtains a movement of the vehicle, in operation 411.

The reason for detecting the movement of the collector and simultaneously obtaining the movement of the vehicle is to determine whether mutual positions between the collector and the subject have been changed due to movement of the vehicle at the moment when the image containing the subject was captured or collected, and determine whether the collector vibrated due to the movement of the vehicle or any other external force.

If the mutual positions between the collector and the subject have been changed or the collector vibrated due to the movement of at least one of the vehicle and the collector when the image was collected, motion blur may occur in the collected image.

The gesture recognition apparatus processes the collected image, determines whether a subject is contained in the processed image, and recognizes a gesture of the subject if it is determined that the subject exists in the image, in operation 412.

Recognizing a gesture includes recognizing information regarding the form and movement of the subject.

Then the gesture recognition apparatus determines whether the mutual positions between the collector and the subject have been changed due to the movement of the vehicle when the image was captured or collected, in operation 413.

Upon determining that the vehicle did not move, the gesture recognition apparatus may determine whether the collector has moved, in operation 414, and determine an operating instruction that corresponds to the recognized gesture information, in operation 415.

Determining whether the collector has moved includes determining whether the collector vibrated due to an external force, such as movement of the user while the vehicle is not moving.

On the other hand, if determining that the collector has moved while the vehicle was not moving, the gesture recognition apparatus corrects the gesture information based on information on movement of the collector, in operation 416, and determines an operating instruction that corresponds to the corrected gesture information.

For example, if determining that the collector vibrated due to an external force, such as a movement of the user inside the vehicle while the vehicle stopped, the gesture recognition apparatus corrects the recognized gesture based on the level and direction of the vibration applied to the collector.

If determining that the vehicle has moved, the gesture recognition apparatus corrects the gesture information based on the information of the movement of the vehicle, in operation 418.

In other words, in collecting information of the subject by means of the collector, a gesture that looks as if the subject moves may be recognized as that the mutual positions between the collector and the subject are changed according to a direction of a force applied to the collector, the force corresponding to a movement of the vehicle.

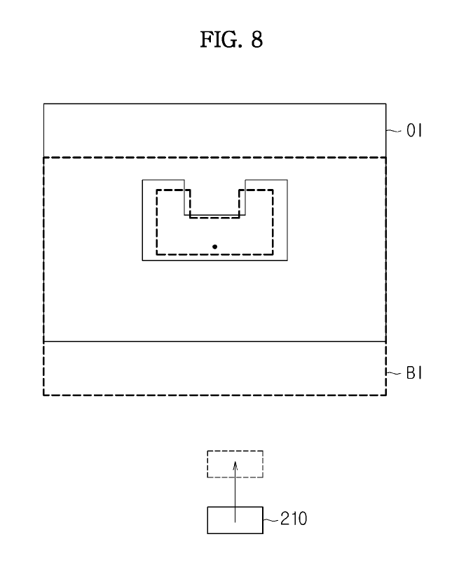

For example, referring to FIG. 8, as the speed of the vehicle abruptly increases and thus a change in speed of the vehicle is greater than a reference amount of change in speed, i.e., the vehicle runs with a burst of speed, the collector 210 moves forward instantaneously, which makes the distance between the collector and the subject (e.g., the user's hand) farther and thus an image that looks as if the subject moves backward may be captured.

As such, since the gesture recognition apparatus may misrecognize the gesture due to the movement of the vehicle, as the vehicle moves while the image of the subject is captured, the gesture recognition apparatus may correct positions of the subject over time based on the movement of the vehicle.

For example, if it is determined from the result of gesture recognition that the vehicle moved forward by +5 while the subject moved backward by −5, it is determined that the subject did not move.

Then, the gesture recognition apparatus may determine whether the collector has moved while the vehicle is moving, in operation 419, and determine an operating instruction that corresponds to the gesture information corrected based on the movement of the vehicle, in operation 420.

Determining whether the collector has moved includes determining whether the collector vibrated due to the movement force of the vehicle or other external forces.

Information on the movement of the collector due to the movement force of the vehicle may be obtained through experiment and stored in advance.

If it is determined that the collector moved while the vehicle moved, the gesture recognition apparatus makes an additional correction to the corrected gesture information based on information on the movement of the collector, in operation 421, and determines an operating instruction for an electronic device that corresponds to the additionally corrected gesture, in operation 422.

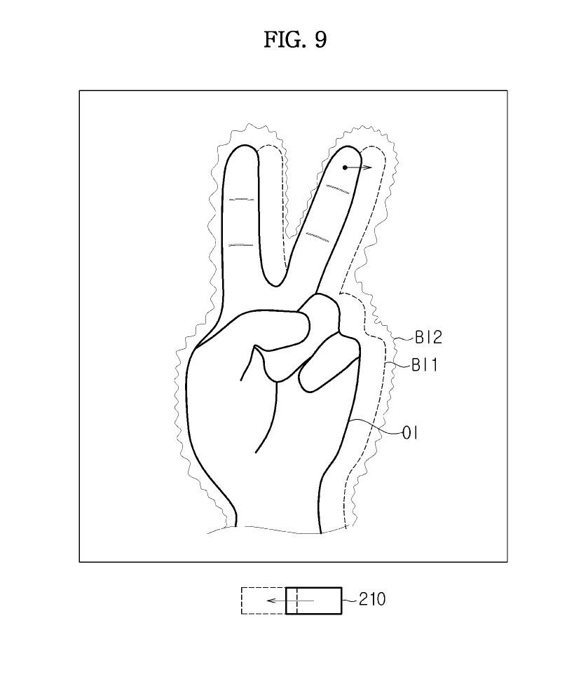

Referring to FIG. 9, if the vehicle moves when an image of the subject is collected, motion blur may occur in the image, the motion blur including first motion blur Bl1 by which the position of the subject is moved by a distance depending on the direction and magnitude of the movement force of the vehicle and second blur Bl2 that occurs when the collector vibrates due to the movement force of the vehicle or any other external force.

At this time, the appearance of the subject unfolding two fingers may be recognized as the subject unfolding three or four fingers or as a gesture that moves to the left.

Accordingly, the gesture recognition apparatus corrects the image of the subject based on extents and directions of movements of the vehicle and collector and the correction is made at certain intervals, thereby obtaining motion blur free images (OI) at certain intervals.

By performing the operations, the gesture recognition apparatus may obtain accurate images of the gesture by obtaining the images OI of an original form of the subject and the information about the movement of the subject.

Then, the gesture recognition apparatus may output the operating instruction intended by the user to the corresponding electronic device, which may in turn operate in response to the operating instruction.

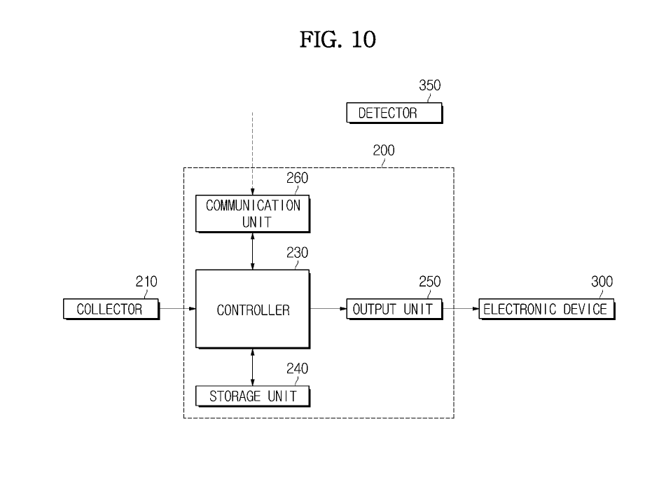

FIG. 10 is a block diagram of the gesture recognition apparatus 200, according to yet another embodiment.

Referring to FIG. 10, the gesture recognition apparatus 200 includes the controller 230, the storage unit 240, the output unit 250, and the communication unit 260, receiving signals sent from the collector 210 and detector 350, recognizing a gesture based on the received signals, and determining an operating instruction that corresponds to the recognized gesture.

The detector 350 is the same as the second detector of the embodiment of FIG. 6, so the description of the detector 350 will be omitted.

The gesture recognition apparatus 200 and the collector 210 may be integrated in a single module.

In this embodiment, as the collector 210, storage unit 240, output unit 250, and communication unit 260 are the same as what are shown in the previous embodiment of FIG. 6, description of them will be omitted.

The controller 230 recognizes a gesture based on a subject detection signal collected by the collector 210.

An image of the subject, which may be the subject detection signal, may contain motion blur due to a movement of the vehicle.

Specifically, the collector 210 mounted on the vehicle may be moved as the vehicle moves, and as the mutual positions between the collector 210 and the subject are instantaneously changed, a gesture having different movement information than is intended by the user may be recognized.

Furthermore, as the vehicle movement affects the collector, the collector may vibrate and thus a gesture having different form information than is intended by the user may be recognized.

Vibration of the collector may be predicted based on the movement of the vehicle, so the information on vibration of the collector may be obtained through experiment and stored in advance.

That is, the information regarding the gesture recognized by the controller 230 may include motion blur that occurs due to the movement of the vehicle.

Accordingly, upon recognition of a gesture, the controller 230 may correct the gesture information based on the vehicle movement information, and then determine an operating instruction for an electronic device 300 that corresponds to the corrected gesture information.

Furthermore, the controller 230 may check a movement of the collector as the vehicle moves, and make a second correction to the gesture information based on the collector movement.

For example, the controller 230 may set at least a part of the subject in the image as a reference part, and correct the form and movement information of the subject by adjusting the reference part based on extent and direction of the vehicle movement.

Accordingly, information on the form and movement of the gesture made by the user may be obtained.

The information about the vehicle movement may include information on acceleration of the vehicle.

The controller 230 may receive information on the speed of all the wheels from the wheel speed sensor equipped in the vehicle, obtain information about an actual speed of the vehicle based on the information about the received speed of all the wheels, and obtain information on acceleration of the vehicle based on the information on the actual speed of the vehicle.

The controller 230 may also obtain the information on acceleration of the vehicle based on information on the yaw rate received from the yaw rate sensor equipped in the vehicle.

The controller 230 may also obtain the information on acceleration of the vehicle based on information on angular speed information received from the gyro sensor equipped in the vehicle.

It is also possible for the controller 230 to directly receive the information on the acceleration of the vehicle from the acceleration sensor equipped in the vehicle.

The controller 230 may correct gesture movement information by sequentially applying information on movement of the vehicle 1 over time while the subject is detected.

For example, if a subject has been detected for 2 seconds, the controller 230 may make a first correction to an image of the subject based on the direction and extent of vehicle movement for 1 second from the start of detection and make a second correction to the first corrected image based on the direction and extent of a vehicle movement for the remaining 1 second.

Making the first and second corrections to the image of the subject includes correcting the position and form of the subject.

By doing this, the controller 230 may obtain a more accurate appearance of the gesture by eliminating the motion blur part from the recognized gesture appearance information, i.e., obtain motion blur free gesture information, and obtain information on the movement of the gesture by checking a change in positions of the corrected gesture over time.

Here, the movement information may include moving directions and moving distances of the subject.

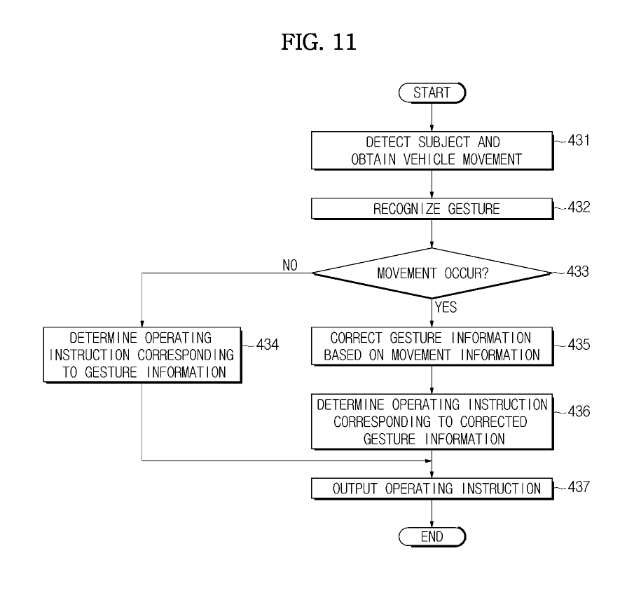

FIG. 11 is a flowchart illustrating a method for controlling a gesture recognition apparatus in the interior of a vehicle, according to yet another embodiment.

The gesture recognition apparatus collects an image of the interior of the vehicle when the driver or a passenger is in the vehicle and detects a movement of the vehicle, in operation 431.

The reason for obtaining the vehicle movement while the image of the interior of the vehicle is collected is to determine whether mutual positions between the collector and the subject has been changed due to the vehicle movement at a moment when the image containing the subject is collected.

This is because motion blur is likely to occur in the collected image when there is a change in mutual positions between the collector and the subject due to the vehicle movement while the image is collected.

The gesture recognition apparatus processes the collected image, determines whether a subject is contained in the processed image, and recognizes a gesture of the subject if it is determined that the subject exists in the image, in operation 432.

Recognizing a gesture includes recognizing information regarding the appearance in form, and movement, of the subject.

Then the gesture recognition apparatus determines whether the vehicle has moved while the subject image is captured or collected, in operation 433.

The gesture recognition apparatus determines an operating instruction that corresponds to the information on the gesture for which the vehicle did not move, in operation 434.

Determining whether the vehicle has moved may include determining whether mutual positions between the collector and the subject have been changed because the position of the collector has instantaneously moved due to vehicle movement.

Upon determining that the vehicle has moved, the gesture recognition apparatus corrects gesture information based on the vehicle movement information, in operation 435, and determines an operating instruction that corresponds to the corrected gesture information, in operation 436.

In other words, in collecting information of the subject by means of the collector, a gesture that looks as if the subject moves may be recognized as mutual positions between the collector and the subject changing according to the direction of a force applied to the collector, the force corresponding to movement of the vehicle.

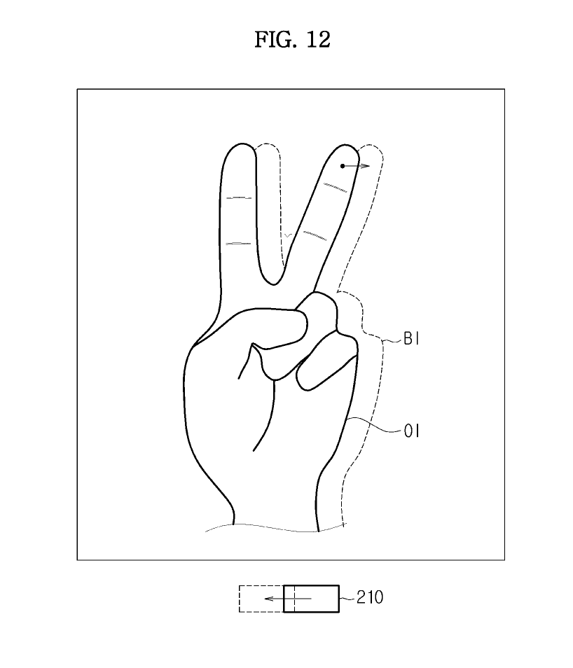

Referring to FIG. 12, as the vehicle runs with a burst of speed at more than a reference speed change rate and turns to the left, i.e., as the collector 210 is instantaneously moved to the left due to the burst of speed and left-turn of the vehicle, left and right positions between the collector 210 and the subject (i.e., the user's hand) become farther apart, and then an image that looks as if the subject moves to the right may be collected by the collector 210.

In other words, when the vehicle moves while an image of the subject is collected, motion blur Bl occurs in the image, by which the position of the subject in the image is moved by a distance depending on the direction and magnitude of the vehicle movement force.

At this time, the form of the subject unfolding two fingers may be recognized as a form of the subject unfolding three or four fingers or as a gesture that moves to the left.

As such, since the gesture recognition apparatus may misrecognize the gesture due to movement of the vehicle, as the vehicle moves while the image of the subject is captured, the gesture recognition apparatus may correct positions of the subject over time based on the movement of the vehicle.

Accordingly, the gesture recognition apparatus corrects the image of the subject based on an extent and direction of the vehicle movement and such image correction is made at certain intervals, thereby obtaining motion blur free images of the subject (OI) at certain intervals.

Furthermore, it is also possible for the gesture recognition apparatus to check the magnitude and direction of the force that corresponds to the vehicle movement and predict the level and direction of vibration to be applied to the collector 210 based on the magnitude and direction of the force.

The gesture recognition apparatus may also make additional correction to the gesture information based on the level and direction of the vibration predicted for the collector 210.

By doing these operations, the gesture recognition apparatus may obtain accurate images of the gesture by obtaining the images OI that has an original form of the subject and the information on the movement of the subject.

Then, the gesture recognition apparatus may output a determined operating instruction intended by the user to a corresponding electronic device, which may in turn operate in response to the operating instruction.

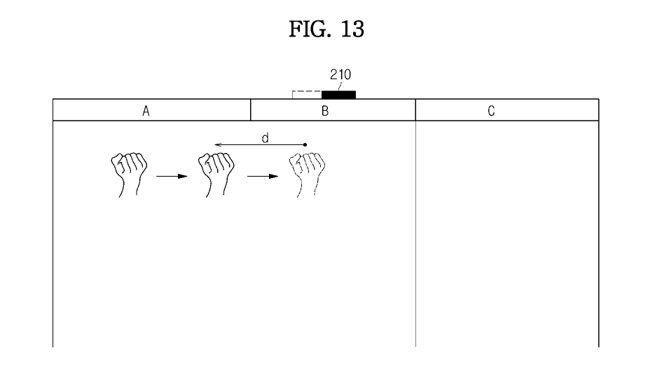

FIG. 13 shows how to perform gesture recognition in the gesture recognition apparatus 200, according to an embodiment.

The gesture recognition apparatus 200 may divide the interior space of the vehicle into multiple sections A, B, and C, for example, and store information regarding the electronic devices included in the respective sections A, B, and C and gesture information that corresponds to operating instructions for respective electronic devices.

Having detected the subject in any of the sections A, B, and C, the gesture recognition apparatus may determine the area in which the subject is detected, determine an operating instruction for a corresponding electronic device which corresponds to the gesture information, and sends the operating instruction to the corresponding electronic device.

The gesture recognition apparatus may correct the recognized gesture information based on at least one of the vehicle movement information and the collector movement information, and determine an operating instruction for an electronic device which corresponds to the corrected gesture information.

For example, if a vehicle movement occurs while the user is making a gesture to move his hand to the right in the first section A, the mutual positions between the collector 210 and the subject may be changed and an image of the subject that looks as if the subject moves to the second section B may be collected by the collector 210.

Then the gesture recognition apparatus might misrecognize that a gesture has been made in both the first and second sections A and B, and output a different operating instruction than intended by the user. To prevent this, the gesture recognition apparatus in accordance with an embodiment of the present disclosure may correct the subject movement information d based on the direction and magnitude of a force that corresponds to vehicle movement, thereby recognizing that the gesture has been made in the first section A and accordingly outputting an operating instruction that corresponds to the corrected gesture information to a corresponding electronic device included in the first section A.

Hence, the user may accurately determine in which section the user has made the gesture, and thus control the corresponding electronic device as intended by the user.

As such, controlling operation of the electronic devices in each of the multiple sections may further increase gesture recognition rate, thereby improving feeling of satisfaction by the user.

In accordance with the present disclosure, distinguishing a movement due to an external force from a movement of a subject for gesture recognition may increase the accuracy of gesture recognition.

This leads to an accurate recognition of an operating instruction intended by the user, thereby reducing the number of times of making the same gesture and thus increasing user convenience.

Accordingly, the driver may easily manipulate various electronic devices equipped in the vehicle while driving, which may again increase the user convenience and improve driving safety.

This enables improvement of the quality of the gesture recognition apparatus and vehicle having the same, raising their commercial values.

Several embodiments have been described, but a person of ordinary skill in the art will understand and appreciate that various modifications can be made without departing the scope of the present disclosure. Thus, it will be apparent to those ordinary skilled in the art that the disclosure is not limited to the embodiments described, which have been provided only for illustrative purposes.

What is claimed is:

1. A vehicle comprising:
a collector for collecting information about a subject;
a first detector for detecting movement of the collector;
a second detector for detecting movement of the vehicle; and
a gesture recognition apparatus for recognizing a gesture based on the information on the subject,
wherein the gesture recognition apparatus comprises:
a storage unit for storing an operating instruction for an electronic device which corresponds to the gesture information; and a controller for correcting the recognized gesture information based on information on the movement of the vehicle and information on the movement of the collector, and determining an operating instruction for an electronic device which corresponds to the corrected gesture information.

2. The vehicle of claim 1, wherein the controller is configured to
obtain information about a form of the gesture in correcting the gesture information.

3. The vehicle of claim 2, wherein the gesture recognition apparatus further comprises a communication unit for receiving traveling information of the vehicle, and
wherein the controller is configured to obtain information on movement of the vehicle based on the traveling information, make an additional correction to the corrected gesture information based on the information on the movement of the vehicle, and determine an operating instruction for an electronic device which corresponds to the additionally corrected gesture information.

4. The vehicle of claim 3, wherein the traveling information of the vehicle comprises information on a wheel speed of the vehicle and information on an actual speed of the vehicle.

5. The vehicle of claim 4, further comprising: a second detector for detecting the movement of the vehicle,
wherein the gesture recognition apparatus further comprises a communication unit for receiving the information on the movement of the vehicle, and
wherein the controller is configured to make an additional correction to the corrected gesture information based on the information on the movement of the vehicle, and determine an operating instruction for an electronic device which corresponds to the additionally corrected gesture information.

6. The vehicle of claim 5, wherein the second detector comprises
at least one of an acceleration sensor, a yaw rate sensor, a gyro sensor, and a wheel speed sensor.

7. A gesture recognition apparatus comprising:
a collector for collecting information on a subject;
a detector for detecting movement of the collector;
a storage unit for storing an operating instruction for an electronic device which corresponds to the gesture information; and
a controller for obtaining gesture information based on the information on the subject, correcting the gesture information based on the information about the movement of the collector, and determining an operating instruction for an electronic device which corresponds to the corrected gesture information; and
an output unit for outputting the operating instruction to the electronic device.

8. The gesture recognition apparatus of claim 7, wherein the collector comprises an image collector for collecting an image of the subject for gesture recognition.

9. The gesture recognition apparatus of claim 7, wherein the collector comprises an optical sensor for receiving light reflected from the subject.

10. The gesture recognition apparatus of claim 7, wherein the controller is configured to obtain information on a form of the gesture in correcting the gesture information.

11. The gesture recognition apparatus of claim 7, further comprising:
a communication unit for receiving traveling information of a vehicle,
wherein the controller is configured to obtain information on movement of the vehicle based on the traveling information, and make an additional correction to the corrected gesture information based on the information on the movement of the vehicle.

12. The gesture recognition apparatus of claim 7, further comprising: a communication unit for receiving information about movement of a vehicle,
wherein the controller is configured to make an additional correction to the corrected gesture information based on the information about the movement of the vehicle.

13. The gesture recognition apparatus of claim 7, wherein the collector and the detector are integrated into a unit.

14. The gesture recognition apparatus of claim 12, wherein the information of movement of a vehicle comprises at least one of acceleration information, yaw rate information, angular speed information, wheel speed information, and actual speed information of the vehicle.

15. A method for controlling a gesture recognition apparatus included in a vehicle, the method comprising:
collecting information on a subject within the vehicle by means of a collector;
obtaining a gesture of the subject;
detecting movement of the collector in collecting the information on the subject;
correcting information on the gesture based on the information on the movement of the collector;
determining an operating instruction for an electronic device which corresponds to the corrected gesture information; and
outputting the operating instruction to the electronic device.

16. The method of claim 15, wherein correcting information on the gesture based on the information on the movement of the collector comprises
receiving traveling information of the vehicle;
obtaining information on movement of the vehicle based on the traveling information; and
making an additional correction to the corrected gesture information based on the information on the movement of the vehicle.

17. The method of claim 15, wherein correcting information about the gesture based on the information on the movement of the collector comprises
receiving information on movement of the vehicle; and
making an additional correction to the corrected gesture information based on the information on the movement of the vehicle.

18. The gesture recognition apparatus of claim 17, wherein the information of movement of a vehicle comprises at least one of acceleration information, yaw rate information, angular speed information, wheel speed information, and actual speed information of the vehicle.
